(19) United States
(12) Patent Application Publication
(10) Pub. No.: US 2012/0062585 A1
(43) Pub. Date: Mar. 15, 2012

(54) VECTOR GRAPHIC DRAWING DEVICE

(75) Inventors: Akira Torii, Tokyo (JP); Yoshiyuki Kato, Tokyo (JP)

(73) Assignee: Mitsubishi Electric Corporation, Tokyo (JP)

(21) Appl. No.: 13/321,349

(22) PCT Filed: May 19, 2009
(86) PCT No.: PCT/JP09/02203

§ 371 Date: Nov. 18, 2011

(51) Int. Cl. G09G 5/02

(52) U.S. Cl. 345/589

(57) ABSTRACT

Disclosed is a vector graphic drawing device in which when drawing a plurality of graphics, an outline drawing unit 12 stores outline information about the plurality of graphics in an outline buffer 13, and, when creating pixels, a pixel creating unit 14 refers to the outline information about the plurality of graphics stored in the outline buffer 13 to determine a color of each pixel in a portion in which the plurality of graphics overlap one another, and draws the pixels in a frame buffer 16. Accordingly, a duplicated drawing process is prevented from being performed on the portion in which the plurality of graphics overlap one another. As a result, the graphic drawing can be speeded up.

### FIELD OF THE INVENTION

The present invention relates to a vector graphic drawing device which draws a vector graphic or an outline font whose outline is defined by an expression.

### BACKGROUND OF THE INVENTION

Each of a vector graphic and an outline font has an outline which is defined by an expression, and is easy to become deformed, such as become enlarged, reduced, or rotated. Furthermore, each of them has the property of not deteriorating in its image quality even if it becomes deformed.

However, when displaying a vector graphic or an outline font on a display device, such as an LCD, it is necessary to perform a process of drawing the outline according to an expression of the outline and filling the inside of the outline after transforming the coordinates of the vector data about the vector graphic or the outline font into coordinates on a frame buffer (refer to patent reference 1).

FIG. 15 is an explanatory drawing showing an outline of the filling process of filling a graphic.

First, the outline of the graphic is drawn in a work memory while information showing whether the outline is directed upward or downward is recorded in the work memory (refer to FIG. 15(a)).

Next, the outline is read from the work memory along with each scan line, and, when the outline is directed upward and the scan line and the upward directed outline cross each other, the number of crossings is incremented by 1, whereas when the outline is directed downward and the scan line and the downwardly directed outline cross each other, the number of crossings is decremented by 1 (refer to FIG. 15(b)).

Then, after the number of crossings of each pixel is determined, the pixels which are targets to be drawn are determined according to the number of crossings, and the pixels which are targets to be drawn are drawn.

More specifically, when a Non-Zero rule (refer to FIG. 15(c)) is applied as a fill rule to fill each pixel, all the pixels whose number of crossings is not “0” are drawn.

As an alternative, when an Even-Odd rule (refer to FIG. 15(d)) is applied as a fill rule for pixels, all the pixels whose number of crossings is odd are drawn.

Although this drawing process is usually carried out through software processing by a CPU, there is a case in which such a drawing process is carried out via hardware at a high speed.

Furthermore, a drawing device which stores the coordinates of each of points of intersection between the outline of a graphic and scan lines, and sorts them at the time of filling the inside of the outline has been also proposed (refer to patent reference 1).

The drawing device disclosed by patent reference 1 is based on the premise that one graphic is drawn at a time. Therefore, when drawing a plurality of graphics which differ in their respective drawn colors or the like, the drawing device draws the plurality of graphics by sequentially superimposing these graphics onto each other.

For example, when drawing two graphics which overlap each other, as shown in FIG. 16, the drawing device superimposes the color of the graphic (2) onto the portion in which they overlap each other after painting the overlapping portion with the color of the graphic (1).

### RELATED ART DOCUMENT

### Patent Reference

Patent reference 1: Japanese Patent Application Publication No. Hei 2-275592 (pp. 4-5)

Because the conventional vector graphic drawing device is constructed as above, when drawing a plurality of graphics which differ in their respective drawn colors or the like, the drawing device needs to draw the plurality of graphics by sequentially superimposing these graphics onto each other. Therefore, for example, when drawing two graphics which overlap each other, the conventional drawing device superimposes the color of the graphic (2) onto the portion in which they overlap each other after painting the overlapping portion with the color of the graphic (1). A problem is therefore that drawing the graphic (1) is a useless process as a result, and hence the efficiency of the drawing gets worse.

The present invention is made in order to solve the above-mentioned problem, and it is therefore an object of the present invention to provide a vector graphic drawing device which can eliminate a useless drawing process at the time of drawing a plurality of graphics having an overlapping portion, thereby being able to provide an improvement in the speed of graphic drawing.

### SUMMARY OF THE INVENTION

In accordance with the present invention, there is provided a vector graphic drawing device in which when drawing a plurality of graphics, an outline drawing unit stores outline information about the plurality of graphics in an outline buffer, and, when creating pixels, a pixel creating unit refers to the outline information about the plurality of graphics stored in the outline buffer to determine a color of each pixel in a portion in which the plurality of graphics overlap one another, and draws the pixels in a frame buffer.

Accordingly, because a duplicated drawing process is prevented from being performed on the portion in which the plurality of graphics overlap one another, the graphic drawing can be speeded up.

### BRIEF DESCRIPTION OF THE FIGURES

FIG. 1 is a block diagram showing a vector graphic drawing device in accordance with Embodiment 1 of the present invention;

FIG. 2 is an explanatory drawing showing two graphics (a graphic (1) and a graphic (2)) having an overlapping portion;

FIG. 3 is an explanatory drawing showing values (outline information) in an outline buffer 13 at the time when a process of storing the outline information about the graphic (1) in the outline buffer 13 is completed;

FIG. 4 is an explanatory drawing showing a one-pixel buffer region in the outline buffer 13;

FIG. 5 is an explanatory drawing showing values (outline information) in the outline buffer 13 at the time when a process of storing the outline information about the graphic (2) in the outline buffer 13 is completed;

FIG. 6 is an explanatory drawing showing pixels which are created from the outline information about the graphic (1);

FIG. 7 is an explanatory drawing showing pixels which are created from the outline information about the graphic (2);

FIG. 8 is an explanatory drawing showing a result of drawing performed by a pixel creating unit 14;

FIG. 9 is an explanatory drawing showing five graphics (a graphic (1), a graphic (2), a graphic (3), a graphic (4), and a graphic (5)) having overlapping portions;

FIG. 10 is an explanatory drawing showing the outline buffer 13 at the time when the pieces of outline information about the graphics (1) to (4) are stored;

FIG. 11 is an explanatory drawing showing a result of drawing performed by the pixel creating unit 14 at the time when the graphics (1) to (4) are drawn;

FIG. 12 is an explanatory drawing showing five graphics (a graphic (1), a graphic (2), a graphic (3), a graphic (4), and a graphic (5)) having overlapping portions;

FIG. 13 is an explanatory drawing showing the outline buffer 13 in which an overflow occurs when the outline information about the graphic (4) is stored;

FIG. 14 is an explanatory drawing showing a result of drawing performed by the pixel creating unit 14 at the time when the graphics (1) to (3) are drawn;

FIG. 15 is an explanatory drawing showing an outline of a filling process; and

FIG. 16 is an explanatory drawing showing two graphics having an overlapping portion.

### EMBODIMENTS OF THE INVENTION

Hereafter, in order to explain this invention in greater detail, the preferred embodiments of the present invention will be described with reference to the accompanying drawings.

### Embodiment 1

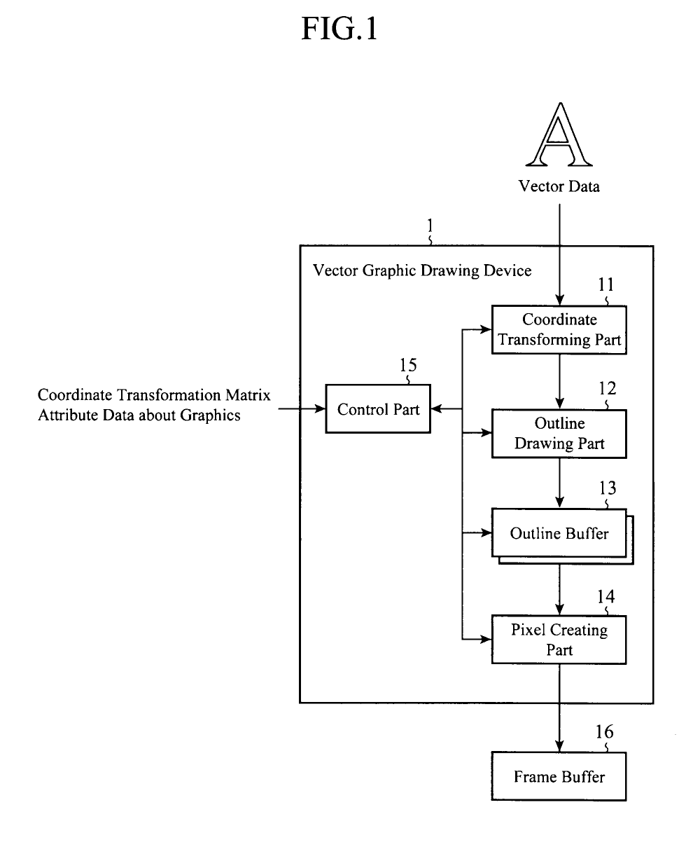

FIG. 1 is a block diagram showing a vector graphic drawing device in accordance with Embodiment 1 of the present invention.

In FIG. 1, the vector graphic drawing device 1 performs drawing of a vector graphic or an outline font (an outline font is handled as a vector graphic in this Embodiment 1 because it is considered that an outline font is a kind of vector graphic).

A coordinate transforming part 11 carries out a process of transforming the coordinates of vector data which constructs the outline of a graphic into coordinates on a frame buffer 16 according to a coordinate transformation matrix set up by a control part 15. The coordinate transforming part 11 constructs a coordinate transforming unit.

An outline drawing part 12 carries out a process of performing a rasterizing process on the vector data of a graphic whose coordinates have been transformed by the coordinate transforming part 11 to convert the vector data into raster data, and determining a point of intersection of the outline of the graphic and each scan line to store outline information showing the point of intersection in an outline buffer 13. The outline drawing part 12 constructs an outline drawing unit.

The outline buffer 13 is a memory having a storage element for each pixel and having the same resolution as the frame buffer 16 (e.g. the memory is comprised of 8 bits of storage space per pixel), and stores outline information about a plurality of graphics outputted from the outline drawing part 12.

A pixel creating part 14 carries out a process of creating pixels with reference to both attribute data about each graphic provided from the control part 15 (e.g. information showing the color of each graphic), and the outline information stored in the outline buffer 13, and drawing the pixels in the frame buffer 16.

More specifically, the pixel creating part 14 carries out a process of determining the color of each pixel in a portion in which the plurality of graphics overlap one another with reference to both the attribute data about the plurality of graphics and the pieces of outline information about the plurality of graphics stored in the outline buffer 13, and drawing the pixels in the frame buffer 16.

The pixel creating part 14 constructs a pixel creating unit.

The control part 15 carries out a process of controlling the coordinate transforming part 11, the outline drawing part 12, the outline buffer 13, and the pixel creating part 14.

The frame buffer 16 is a memory for holding an image which is a result of drawing obtained by the vector graphic drawing device 1.

Next, the operation of the vector graphic drawing device will be explained.

In this Embodiment 1, for the sake of simplicity, an example in which two graphics having an overlapping portion are drawn will be explained.

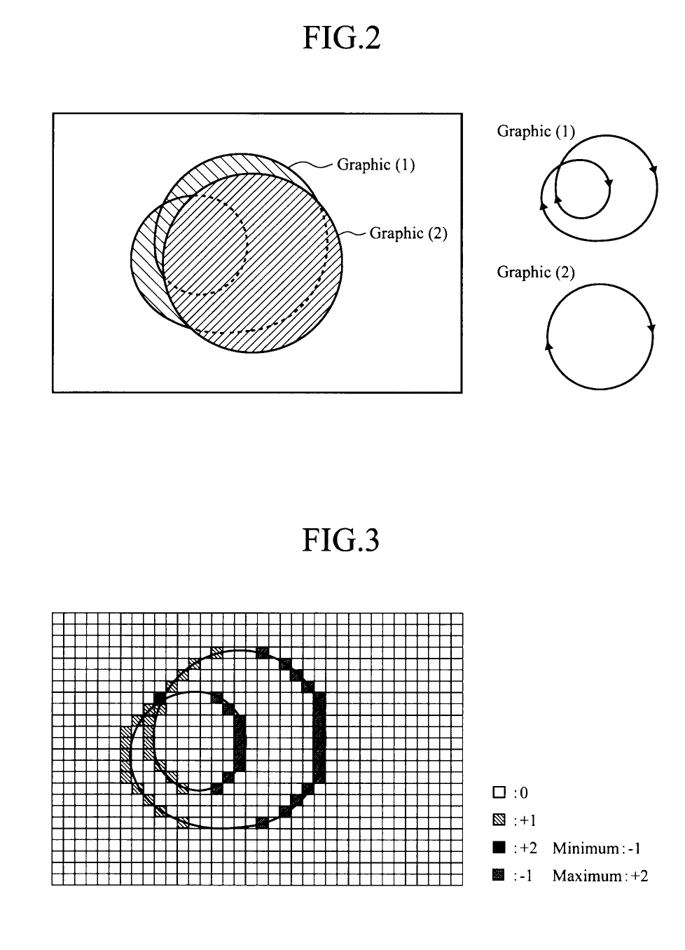

FIG. 2 is an explanatory drawing showing the two graphics (a graphic (1) and a graphic (2)) having an overlapping portion.

Furthermore, in this Embodiment 1, it is assumed that the Non-Zero rule is used as a fill rule to fill each pixel.

First, the control part 15 outputs a command for initializing all the bits of the outline buffer 13 to “0” to the outline drawing part 12 as a preparation for drawing of the graphic (1).

After the outline drawing part 12 initializes all the bits of the outline buffer 13 to “0”, the control part 15 acquires the coordinate transformation matrix of the graphic (1) and the attribute data about the graphic (1) from, for example, a not-shown CPU or external memory.

After acquiring the coordinate transformation matrix of the graphic (1) and the attribute data about the graphic (1), the control part 15 sets the coordinate transformation matrix of the graphic (1) to the coordinate transforming part 11.

When receiving the vector data about the graphic (1), the coordinate transforming part 11 transforms the coordinates of the vector data into coordinates on the frame buffer 16 by performing a coordinate transformation process on the coordinates of the vector data according to the coordinate transformation matrix of the graphic (1) set thereto by the control part 15 to carry out scaling, rotation, parallel translation, and so on of the vector graphic. Because the coordinate transformation process is a known technique, a detailed explanation of the coordinate transformation process will be omitted hereafter.

After the coordinate transforming part 11 performs the coordinate conversion on the vector data about the graphic (1), the outline drawing part 12 converts the vector data into raster data by performing the rasterizing process on the vector data whose coordinates have been converted, and determines a point of intersection of the outline of the graphic (1) and each scan line to store outline information showing the point of intersection in the outline buffer 13. Because the rasterizing process is a known technique, a detailed explanation of the rasterizing process will be omitted hereafter.

More specifically, after determining a point of intersection of the outline of the graphic (1) and each scan line, the outline drawing part 12 adds “1” to the value (outline information) of the pixel corresponding to the point of intersection, which is stored in the outline buffer 13, if the outline at the point of intersection is directed upward.

In contrast, if the outline at the point of intersection is directed downward, the outline drawing part subtracts “1” from the value (outline information) of the pixel corresponding to the point of intersection, which is stored in the outline buffer 13.

FIG. 3 is an explanatory drawing showing the values (outline information) of the outline buffer 13 at the time when the process of storing the outline information about the graphic (1) in the outline buffer 13 is completed.

Although a view having a low resolution is shown in FIG. 3 for the sake of simplicity, the outline buffer has the same resolution as the frame buffer 16 in actuality.

In the example of FIG. 3, each pixel at which the outline is directed upward and crosses a scan line has outline information of “+1”, each pixel at which the outline is directed upward and crosses a scan line two times has outline information of “+2”, each pixel at which the outline is directed downward and crosses a scan line has outline information of “−1”, and each pixel at which the outline does not cross any scan line has outline information of “0”.

When carrying out the process of storing the outline information about the graphic (1) in the outline buffer 13, the outline drawing part 12 holds a minimum and a maximum of the pieces of outline information of all the pixels.

In the example of FIG. 3, the minimum of the pieces of outline information is “−1” and the maximum of them is “+2”.

The outline drawing part 12 calculates the number of bits required to express a value ranging from the minimum to the maximum of the pieces of outline information about the graphic (1). In the case of the graphic (1), because the outline drawing part needs to express a value ranging from the maximum “+2” to the minimum “−1”, three bits including a sign bit are required for expression of a two's complement number.

After calculating the required number of bits (in the case of the graphic (1), three bits), the outline drawing part 12 notifies the control part 15 that the outline drawing part uses the number of bits in the outline buffer 13.

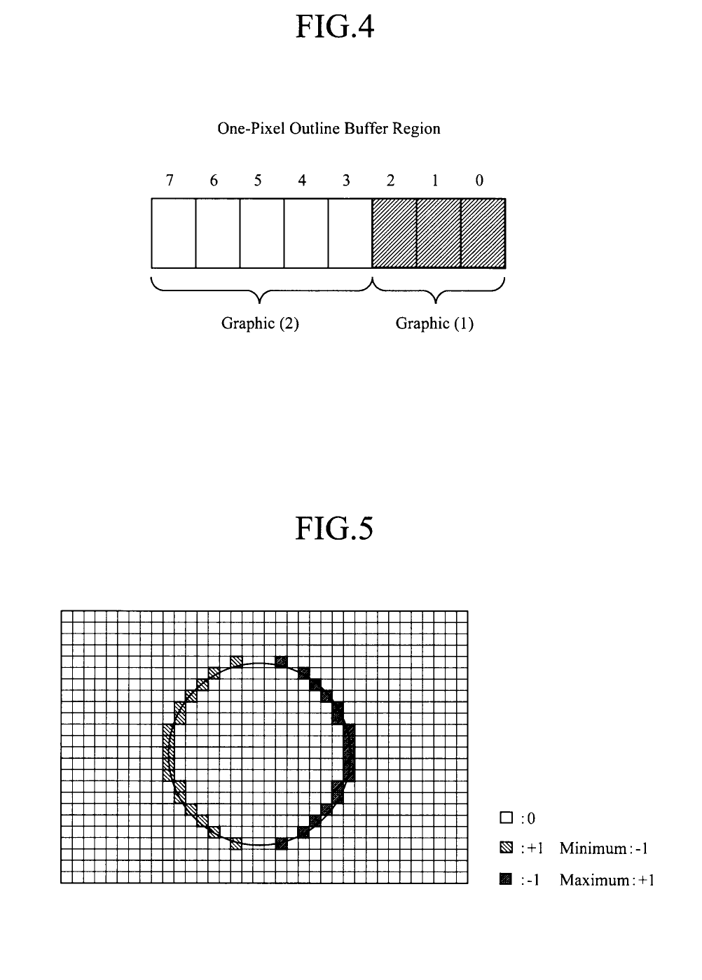

FIG. 4 is an explanatory drawing showing a one-pixel buffer region of the outline buffer 13.

FIG. 4 shows an example in which the outline information about the graphic (1) is held by the three lowermost ones of the bits required for each pixel in the outline buffer 13.

When receiving the notification of the number of bits used for the graphic (1) in the outline buffer 13 from the outline drawing part 12, the control part 15 stores the number of bits used for the graphic (1) therein, and outputs a command for holding the three lowermost bits of the outline buffer 13 to the outline drawing part 12.

As a preparation for drawing of the graphic (2), the control part 15 also outputs a command for initializing the five uppermost bits which are the remaining bits other than the three lowermost bits for holding the outline information about the graphic (1) to “0” to the outline drawing part 12.

After the outline drawing part 12 initializes the five uppermost bits of the outline buffer 13 to “0”, the control part 15 acquires the coordinate transformation matrix of the graphic (2) and the attribute data about the graphic (2) from, for example, the not-shown CPU or external memory.

After acquiring the coordinate transformation matrix of the graphic (2) and the attribute data about the graphic (2), the control part 15 sets the coordinate transformation matrix of the graphic (2) to the coordinate transforming part 11.

When receiving the vector data about the graphic (2), the coordinate transforming part 11 transforms the coordinates of the vector data into coordinates on the frame buffer 16 by performing a coordinate transformation process on the coordinates of the vector data according to the coordinate transformation matrix of the graphic (2) set thereto by the control part 15 to carry out scaling, rotation, parallel translation, and so on of the vector graphic.

After the coordinate transforming part 11 performs the coordinate conversion on the vector data about the graphic (2), the outline drawing part 12 converts the vector data into raster data by performing the rasterizing process on the vector data whose coordinates have been converted, and determines a point of intersection of the outline of the graphic (2) and each scan line to store outline information showing the point of intersection in the outline buffer 13 (because the outline information about the graphic (1) has been stored in the three lowermost bits of the outline buffer 13, the outline drawing part stores the outline information about the graphic (2) in the five uppermost bits of the outline buffer 13, as shown in FIG. 4).

More specifically, after determining a point of intersection of the outline of the graphic (2) and each scan line, the outline drawing part 12 adds “1” to the value (outline information) of the pixel corresponding to the point of intersection, which is stored in the outline buffer 13, if the outline at the point of intersection is directed upward.

In contrast, if the outline at the point of intersection is directed downward, the outline drawing part subtracts “1” from the value (outline information) of the pixel corresponding to the point of intersection, which is stored in the outline buffer 13.

FIG. 5 is an explanatory drawing showing the values (outline information) of the outline buffer 13 at the time when the process of storing the outline information about the graphic (2) in the outline buffer 13 is completed.

Although a view having a low resolution is shown in FIG. 5 for the sake of simplicity, the outline buffer has the same resolution as the frame buffer 16 in actuality.

In the example of FIG. 5, each pixel at which the outline is directed upward and crosses a scan line has outline information of “+1”, and each pixel at which the outline is directed downward and crosses a scan line has outline information of “−1”.

Furthermore, each pixel at which the outline does not cross any scan line has outline information of “0”.

When carrying out the process of storing the outline information about the graphic (2) in the outline buffer 13, the outline drawing part 12 holds a minimum and a maximum of the pieces of outline information of all the pixels.

In the example of FIG. 5, the minimum of the pieces of outline information is “−1” and the maximum of the pieces of outline information is “+1”.

The outline drawing part 12 calculates the number of bits required to express a value ranging from the minimum to the maximum of the pieces of outline information about the graphic (2). In the case of the graphic (2), because the outline drawing part needs to express a value ranging from the minimum “−1” to the maximum “+1”, two bits including a sign bit are required for expression of a two's complement number.

After calculating the required number of bits (in the case of the graphic (2), two bits), the outline drawing part 12 notifies the control part 15 that the outline drawing part uses the number of bits in the outline buffer 13.

When receiving the notification of the number of bits used for the graphic (2) in the outline buffer 13 from the outline drawing part 12, the control part 15 stores the number of bits used for the graphic (2) therein, and outputs a command for holding the five lowermost bits of the outline buffer 13 (the two pieces of outline information about the graphics (1) and (2)) to the outline drawing part 12.

Furthermore, when receiving a command for ending the drawing from, for example, the not-shown CPU or external memory, the control part 15 outputs a creation command for creating pixels to the pixel creating part 14.

When outputting the creation command for creating pixels, the control part 15 outputs bit position information showing the bit position at which the outline information about the graphic (1) is held and the bit position at which the outline information about the graphic (2) is held to the pixel creating part 14 on the basis of the number of bits used for the graphic (1) and the number of bits used for the graphic (2) which are stored therein, and outputs the attribute data about the graphics (1) and (2) which are stored therein to the pixel creating part 14.

When receiving the creation command for creating pixels from the control part 15, the pixel creating part 14 acquires the outline information about the graphic (1) and the outline information about the graphic (2) from the outline buffer 13 with reference to the bit position information outputted from the control part 15.

After acquiring the outline information about the graphic (1) and the outline information about the graphic (2), the pixel creating part 14 creates pixels with reference to both the pieces of outline information and the attribute data about the graphics (1) and (2) outputted from the control part 15, and draws the pixels in the frame buffer 16.

Hereafter, the process of creating pixels performed by the pixel creating part 14 will be explained concretely.

The pixel creating part 14 performs the process of creating pixels by repeating pixel creation in the direction of the scan lines a number of times corresponding to the vertical resolution.

The pixel creating part also performs the pixel creation in the direction of the scan lines by determining the number of crossings that each scan line crosses the outline at each pixel. The number of crossings that each scan line crosses the outline at each pixel is equal to the addition of the value of the outline buffer 13 corresponding to the pixel in question to the number of crossings that the scan line crosses the outline at the pixel located to the left of the pixel in question, and its initial value is “0”.

When the fill rule to fill each pixel is the Non-Zero rule, if the number of crossings that a scan line crosses the outline of a graphic at a pixel is other than “0”, it is determined that the pixel needs to be drawn because the pixel is located inside the graphic.

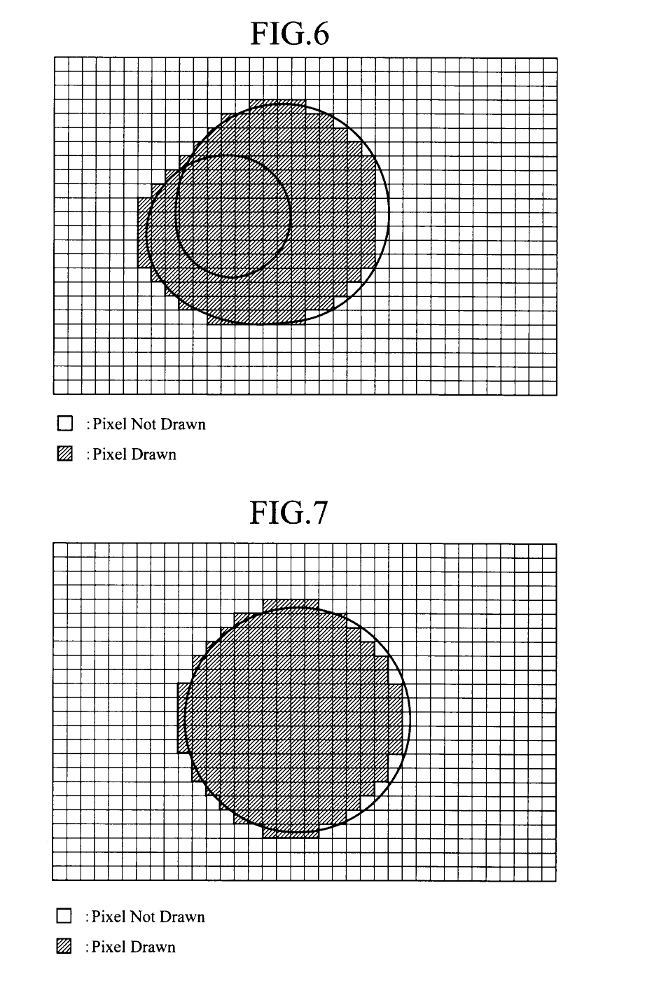

FIG. 6 is an explanatory drawing showing pixels which are created from the outline information about the graphic (1), and FIG. 7 is an explanatory drawing showing pixels which are created from the outline information about the graphic (2).

The pixel creating part 14 simultaneously carries out the pixel creation for the graphic (1) and the pixel creation for the graphic (2), and then determines the color of each pixel.

The pixel creating part determines, as the color of each pixel in the portion in which the graphic (1) and the graphic (2) overlap each other, the color of the graphic (2) which will be drawn later.

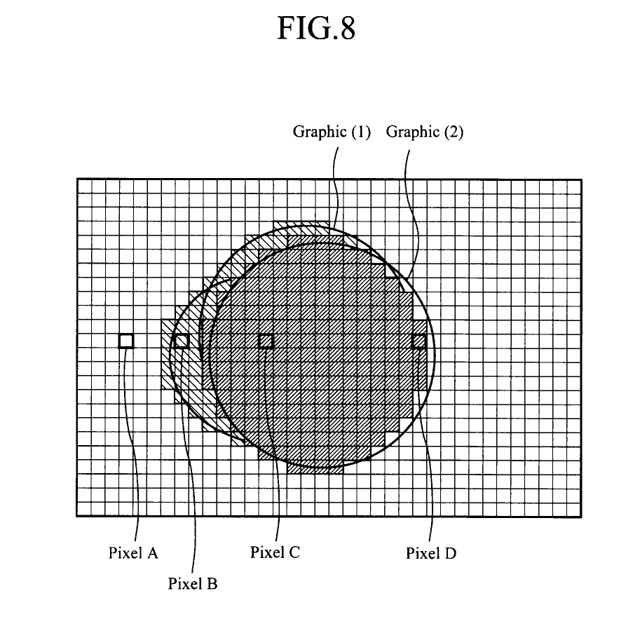

FIG. 8 is an explanatory drawing showing a result of the drawing performed by the pixel creating part 14.

In FIG. 8, because a pixel A is located outside the graphic (1), and outside the graphic (2), the pixel A is not drawn.

Because a pixel B is located inside the graphic (1), and outside the graphic (2), the pixel B is drawn with the color of the graphic (1).

Because a pixel C is located inside the graphic (1), and inside the graphic (2), the pixel C is drawn with the color of the graphic (2).

Because a pixel D is located outside the graphic (1), and inside the graphic (2), the pixel C is drawn with the color of the graphic (2).

When the drawing process performed by the pixel creating unit 14 is completed, the operation of the vector graphic drawing device 1 is completed.

By creating the pixels in the above-mentioned way, the vector graphic drawing device has only to perform the drawing in the frame buffer 16 only once for each pixel, such as the pixel C, in the portion in which the graphic (1) and the graphic (2) overlap each other.

As can be seen from the above description, the vector graphic drawing device in accordance with this Embodiment 1 is constructed in such a way that when drawing a plurality of graphics, the outline drawing part 12 stores the outline information about the plurality of graphics in the outline buffer 13, and, when creating pixels, the pixel creating part 14 refers to the outline information about the plurality of graphics stored in the outline buffer 13 to determine the color of each pixel in the portion in which the plurality of graphics overlap one another, and draws the pixels in the frame buffer 16. Accordingly, a duplicated drawing process is prevented from being performed on the portion in which the plurality of graphics overlap one another. As a result, there is provided an advantage of being able to speed up the graphic drawing.

Furthermore, because the vector graphic drawing device in accordance with this Embodiment 1 is constructed in such a way that in the case in which the Non-Zero rule is applied as the fill rule at the time of creating pixels by means of the pixel creating part 14, when the outline drawing part 12 stores the outline information about each graphic in the outline buffer 13, only a number of bits required to express a value ranging from the minimum to the maximum of the outline information is reserved in the outline buffer 13, a large amount of outline information can be stored in the outline buffer 13. As a result, because many graphics can be drawn simultaneously, there is provided an advantage of being able to speed up the graphic drawing.

In addition, because the vector graphic drawing device in accordance with this Embodiment 1 is constructed in such a way that the pixel creating part 14 makes the color of each pixel in the portion in which the plurality of graphics overlap one another match the color of the graphic which will be drawn later, there is provided an advantage of being able to promptly create the pixels in the portion in which the plurality of graphics overlap one another without carrying out any complicated process.

### Embodiment 2

In above-mentioned Embodiment 1, the example in which in the case in which the Non-Zero rule is applied as the fill rule at the time of creating pixels by means of the pixel creating part 14, when the outline drawing part 12 stores the outline information about each graphic in the outline buffer 13, only a number of bits required to express a value ranging from the minimum to the maximum of the outline information is reserved in the outline buffer 13 is shown. In contrast, in the case in which the fill rule is the Even-Odd rule, because what is necessary is just to determine whether the number of crossings that each scan line crosses the outline is either even or odd, the outline drawing part 12 reserves one bit in the outline buffer 13 when storing the outline information about each graphic in the outline buffer 13.

In accordance with this Embodiment 2, because one bit is always enough as the number of bits in the outline buffer 13 which is assigned to each graphic, a larger amount of outline information can be stored in the outline buffer 13 compared with above-mentioned Embodiment 1. As a result, there is provided an advantage of being able to draw a larger number of graphics simultaneously.

### Embodiment 3

In above-mentioned Embodiment 1, the example in which the outline information about two graphics having an overlapping portion is stored in the outline buffer 13 is shown. However, there is a case in which there are many graphics which are targets to be drawn, and the number of bits required to store the outline information about all the graphics cannot be reserved in the outline buffer 13.

In such a case, the outline drawing part 12 can store the outline information about some graphics in the outline buffer 13, and, after the pixel creating part 14 creates pixels with reference to the outline information stored in the outline buffer 13, store the outline information about the remaining graphics in the outline buffer 13.

An example in which five graphics having overlapping portions are drawn will be explained hereafter.

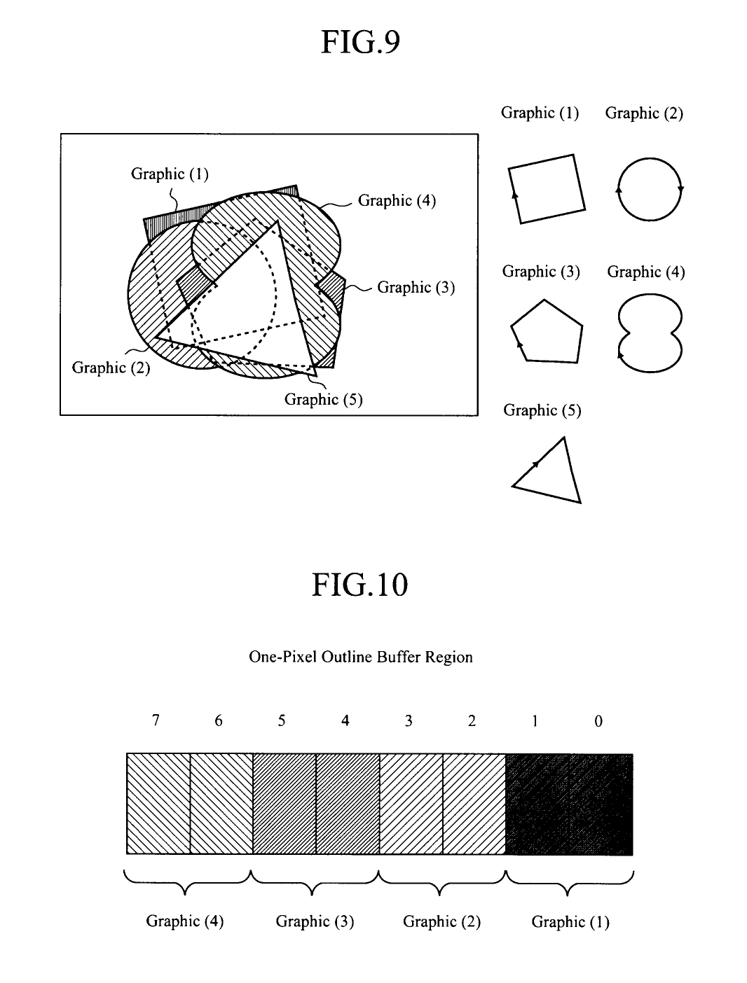

FIG. 9 is an explanatory drawing showing the five graphics (a graphic (1), a graphic (2), a graphic (3), a graphic (4), and a graphic (5)) having overlapping portions.

Furthermore, in this Embodiment 3, it is assumed that the Non-Zero rule is applied as the fill rule to fill each pixel.

In this case, the coordinate transformation matrix of each of the graphics (1) to (5), and the attribute data and the vector data about each of the graphics (1) to (5) are provided sequentially to the vector graphic drawing device 1, and a command for ending the drawing is finally inputted to the vector graphic drawing device.

In the example of FIG. 9, because each of all the graphics (1) to (5) does not have an outline which crosses itself, the outline information about each graphic stored in the outline buffer 13 has a minimum “−1” and a maximum “+1”, and can be expressed by two bits.

Therefore, in the case in which the outline buffer 13 is comprised of 8 bits of storage space per pixel, the pieces of outline information about the graphics (1) to (4) can be stored simultaneously in the outline buffer 13, though the outline information about the graphic (5) cannot be stored simultaneously with the pieces of outline information about the other graphics.

First, when the coordinate transformation matrix of the graphic (1) and the attribute data about the graphic (1) are provided to the control part 15, and the vector data about the graphic (1) is provided to the coordinate transforming part 11, the coordinate transforming part 11 and the outline drawing part 12 carry out processes in the same way that those in accordance with above-mentioned Embodiment 1 do. As a result, the outline drawing part 12 stores the outline information about the graphic (1) in the outline buffer 13.

After storing the outline information about the graphic (1) in the outline buffer 13, the outline drawing part 12 notifies the control part 15 that the outline drawing part uses two bits in the outline buffer 13.

Next, when the coordinate transformation matrix of the graphic (2) and the attribute data about the graphic (2) are provided to the control part 15, and the vector data about the graphic (2) is provided to the coordinate transforming part 11, the coordinate transforming part 11 and the outline drawing part 12 carry out processes in the same way that those in accordance with above-mentioned Embodiment 1 do. As a result, the outline drawing part 12 stores the outline information about the graphic (2) in the outline buffer 13.

After storing the outline information about the graphic (2) in the outline buffer 13, the outline drawing part 12 notifies the control part 15 that the outline drawing part uses two bits in the outline buffer 13.

After that, the outline drawing part 12 sequentially stores the outline information about the graphic (3) and the outline information about the graphic (4) in the outline buffer 13 in the same way, and then notifies the control part 15 that the outline drawing part uses two bits in the outline buffer 13 for each of the pieces of outline information.

When receiving the notification of the number of bits used for the graphic (4) in the outline buffer 13 from the outline drawing part 12, the control part 15 determines that all the bits (8 bits per pixel) of the outline buffer 13 are used, and there is already no space.

FIG. 10 is an explanatory drawing showing the outline buffer 13 at the time when the pieces of outline information about the graphics (1) to (4) are stored.

When determining that there is already no space in the outline buffer, because the outline information about the graphic (5) cannot be stored in the outline buffer 13 even if the coordinate transformation matrix of the graphic (5) and the attribute data about the graphic (5) are provided thereto, the control part 15 outputs a creation command for creating pixels to the pixel creating part 14.

When outputting the creation command for creating pixels, the control part 15 outputs bit position information showing the bit positions at which the pieces of outline information about the graphics (1) to (4) are held to the pixel creating part 14 on the basis of the number of bits used for each of the graphics (1) to (4) which are stored therein, and also outputs the attribute data about the graphics (1) and (4) which are stored therein to the pixel creating part 14.

When receiving the creation command for creating pixels from the control part 15, the pixel creating part 14 acquires the pieces of outline information about the graphics (1) to (4) from the outline buffer 13 with reference to the bit position information outputted from the control part 15, like that in accordance with above-mentioned Embodiment 1.

After acquiring the pieces of outline information about the graphics (1) to (4), the pixel creating part 14 creates pixels with reference to both the pieces of outline information and the attribute data about the graphics (1) to (4) outputted from control part 15, and draws the pixels in the frame buffer 16.

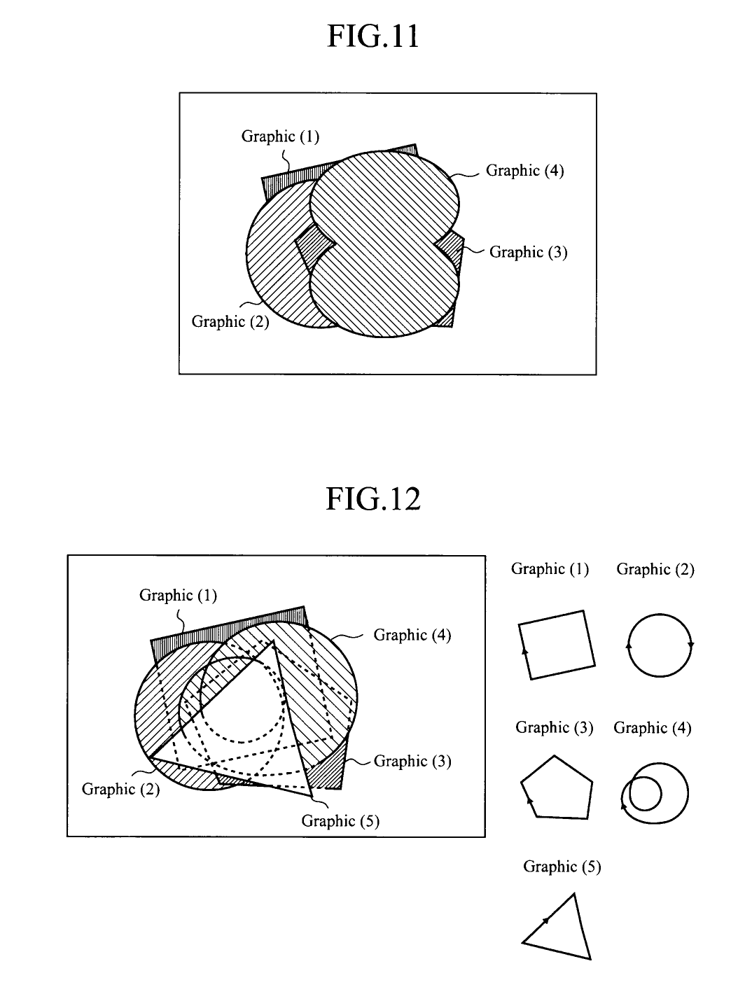

FIG. 11 is an explanatory drawing showing a result of the drawing performed by the pixel creating part 14 at the time when the graphics (1) to (4) are drawn.

After the pixel creating part 14 draws the graphics (1) to (4), the control part 15 outputs a command for initializing all the bits of the outline buffer 13 to “0” to the outline drawing part 12, as a preparation for drawing of the graphic (5).

After all the bits of the outline buffer 13 are initialized to “0”, when the coordinate transformation matrix of the graphic (5) and the attribute data about the graphic (5) are provided to the control part 15, and the vector data about the graphic (5) is provided to the coordinate transforming part 11, the coordinate transforming part 11 and the outline drawing part 12 carry out processes in the same way that those in accordance with above-mentioned Embodiment 1 do. As a result, the outline drawing part 12 stores the outline information about the graphic (5) in the outline buffer 13.

After storing the outline information about the graphic (5) in the outline buffer 13, the outline drawing part 12 notifies the control part 15 that the outline drawing part uses two bits in the outline buffer 13.

Furthermore, when receiving a command for ending the drawing from, for example, the not-shown CPU or external memory, the control part 15 outputs a creation command for creating pixels to the pixel creating part 14, like that in accordance with above-mentioned Embodiment 1.

When outputting the creation command for creating pixels, the control part 15 outputs bit position information showing the bit position at which the outline information about the graphic (5) is held to the pixel creating part 14 on the basis of the number of bits used for the graphic (5) which is stored therein, and also outputs the attribute data about the graphic (5) which is stored therein to the pixel creating part 14.

When receiving the creation command for creating pixels from the control part 15, the pixel creating part 14 acquires the outline information about the graphic (5) from the outline buffer 13 with reference to the bit position information outputted from the control part 15, like that in accordance with above-mentioned Embodiment 1.

After acquiring the outline information about the graphic (5), the pixel creating part 14 creates pixels with reference to both the outline information and the attribute data about the graphic (5) outputted from control part 15, and draws the pixels in the frame buffer 16.

As a result, the drawing of the graphics (1) to (5) is completed.

Next, an example in which five graphics different from those shown in FIG. 9 are drawn will be explained.

FIG. 12 is an explanatory drawing showing the five graphics (a graphic (1), a graphic (2), a graphic (3), a graphic (4), and a graphic (5)) having overlapping portions.

Furthermore, it is assumed that the Non-Zero rule is applied as the fill rule to fill each pixel.

In this case, the coordinate transformation matrix of each of the graphics (1) to (5) and the attribute data and the vector data about each of the graphics (1) to (5) are provided sequentially to the vector graphic drawing device 1, and a command for ending the drawing is finally inputted to the vector graphic drawing device.

In the example of FIG. 12, because each of the graphics (1) to (3) , and (5) does not have an outline which crosses itself, the outline information about each of these graphics stored in the outline buffer 13 has a minimum “−1” and a maximum “+1”, and can be expressed by two bits.

In contrast, because the graphic (4) has an outline which crosses itself, the outline information about this graphic stored in the outline buffer 13 has a minimum “−1” and a maximum “+2”, and needs to be expressed by three bits.

Therefore, in the case in which the outline buffer 13 is comprised of 8 bits of storage space per pixel, the pieces of outline information about the graphics (1) to (3) can be stored simultaneously in the outline buffer 13, though an overflow occurs when the outline drawing part tries to store the outline information about the graphic (4) in the outline buffer.

First, when the coordinate transformation matrix of the graphic (1) and the attribute data about the graphic (1) are provided to the control part 15, and the vector data about the graphic (1) is provided to the coordinate transforming part 11, the coordinate transforming part 11 and the outline drawing part 12 carry out processes in the same way that those in accordance with above-mentioned Embodiment 1 do. As a result, the outline drawing part 12 stores the outline information about the graphic (1) in the outline buffer 13.

After storing the outline information about the graphic (1) in the outline buffer 13, the outline drawing part 12 notifies the control part 15 that the outline drawing part uses two bits in the outline buffer 13.

After that, the outline drawing part 12 sequentially stores the outline information about the graphic (2) and the outline information about the graphic (3) in the outline buffer 13 in the same way, the outline drawing part 12 notifies the control part 15 that the outline drawing part uses two bits in the outline buffer 13 for each of the pieces of outline information.

Next, when the coordinate transformation matrix of the graphic (4) and the attribute data about the graphic (4) are provided to the control part 15, and the vector data about the graphic (4) is provided to the coordinate transforming part 11, the coordinate transforming part 11 and the outline drawing part 12 carry out processes in the same way that those in accordance with above-mentioned Embodiment 1 do. As a result, the outline drawing part 12 tries to carry out a process of storing the outline information about the graphic (4) in the outline buffer 13.

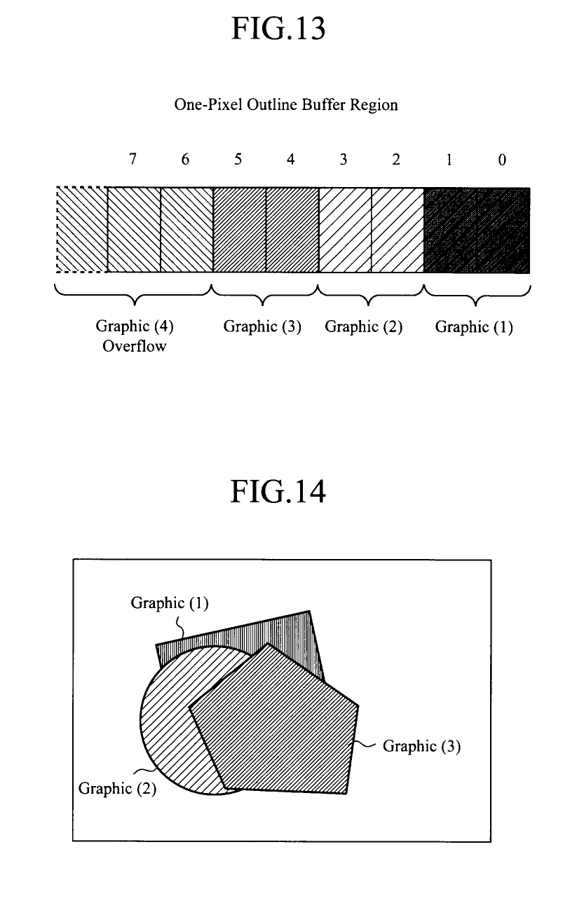

However, three bits are required to store the outline information about the graphic (4), and, at this time, because there are only two bits of free space in the outline buffer 13 and hence there is not enough number of bits to store the outline information, an overflow occurs as shown in FIG. 13 when the outline drawing part tries to store the outline information about the graphic (4) in the outline buffer 13.

When detecting the occurrence of an overflow, the control part 15 outputs a suspension command for suspending the process to the coordinate transforming part 11 and the outline drawing part 12.

After the coordinate transforming part 11 and the outline drawing part 12 suspend their processes, the control part 15 outputs a creation command for creating pixels to the pixel creating part 14.

When outputting the creation command for creating pixels, the control part 15 outputs bit position information showing the bit positions at which the pieces of outline information about the graphics (1) to (3) are held to the pixel creating part 14 on the basis of the number of bits used for each of the graphics (1) to (3) which are stored therein, and also outputs the attribute data about the graphics (1) to (3) which are stored therein to the pixel creating part 14.

When receiving the creation command for creating pixels from the control part 15, the pixel creating part 14 acquires the pieces of outline information about the graphics (1) to (3) from the outline buffer 13 with reference to the bit position information outputted from the control part 15, like that in accordance with above-mentioned Embodiment 1.

After acquiring the pieces of outline information about the graphics (1) to (3), the pixel creating part 14 creates pixels with reference to both the pieces of outline information and the attribute data about the graphics (1) to (3) outputted from control part 15, and draws the pixels in the frame buffer 16.

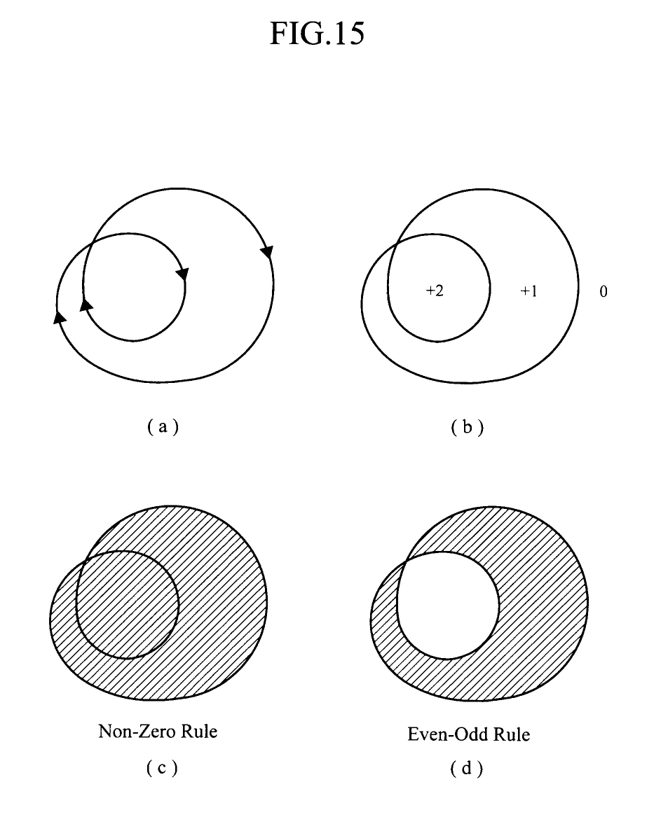

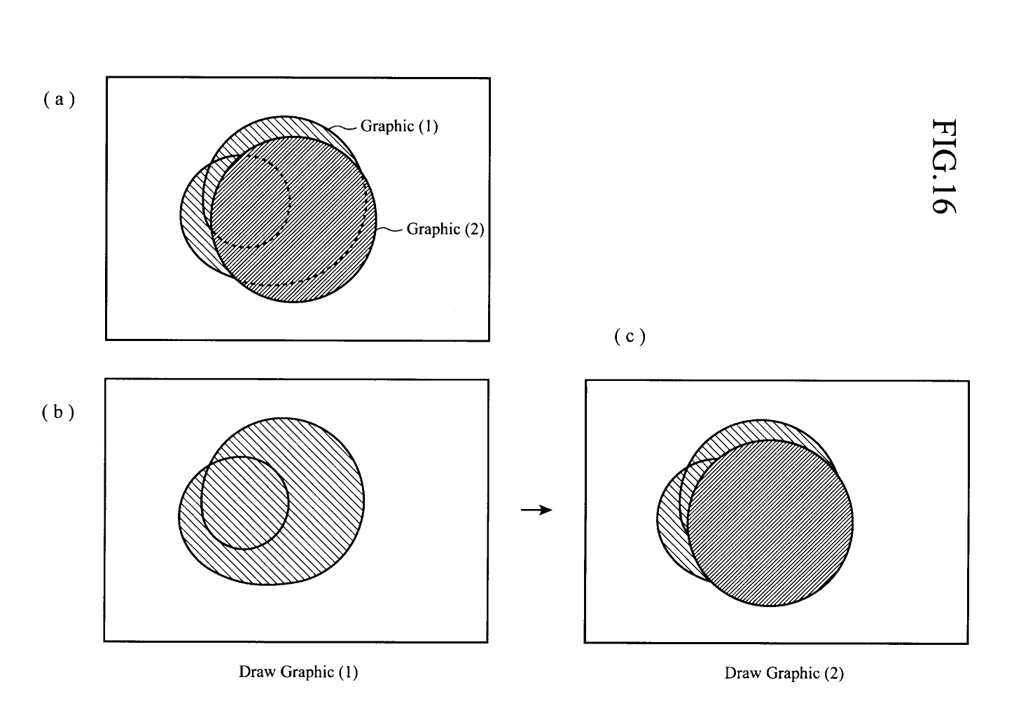

FIG. 14 is an explanatory drawing showing a result of the drawing performed by the pixel creating part 14 at the time when the graphics (1) to (3) are drawn.

After the pixel creating part 14 draws the graphics (1) to (3), the control part 15 outputs a command for initializing all the bits of the outline buffer 13 to “0” to the outline drawing part 12, as a preparation for drawing of the graphics (4) and (5).

After all the bits of the outline buffer 13 are initialized to “0”, when the coordinate transformation matrix of the graphic (4) and the attribute data about the graphic (4) are provided to the control part 15, and the vector data about the graphic (4) is provided to the coordinate transforming part 11, the coordinate transforming part 11 and the outline drawing part 12 carry out processes in the same way that those in accordance with above-mentioned Embodiment 1 do. As a result, the outline drawing part 12 stores the outline information about the graphic (4) in the outline buffer 13.

After storing the outline information about the graphic (4) in the outline buffer 13, the outline drawing part 12 notifies the control part 15 that the outline drawing part uses three bits in the outline buffer 13.

Next, when the coordinate transformation matrix of the graphic (5) and the attribute data about the graphic (5) are provided to the control part 15, and the vector data about the graphic (5) is provided to the coordinate transforming part 11, the coordinate transforming part 11 and the outline drawing part 12 carry out processes in the same way that those in accordance with above-mentioned Embodiment 1 do. As a result, the outline drawing part 12 stores the outline information about the graphic (5) in the outline buffer 13.

After storing the outline information about the graphic (5) in the outline buffer 13, the outline drawing part 12 notifies the control part 15 that the outline drawing part uses two bits in the outline buffer 13.

When receiving a command for ending the drawing from, for example, the not-shown CPU or external memory, the control part 15 outputs a creation command for creating pixels to the pixel creating part 14, like that in accordance with above-mentioned Embodiment 1.

When outputting the creation command for creating pixels, the control part 15 outputs bit position information showing the bit positions at which the pieces of outline information about the graphics (4) and (5) are held to the pixel creating part 14 on the basis of the number of bits used for each of the graphics (4) and (5) which are stored therein, and also outputs the attribute data about the graphics (4) and (5) which are stored therein to the pixel creating part 14.

When receiving the creation command for creating pixels from the control part 15, the pixel creating part 14 acquires the pieces of outline information about the graphics (4) and (5) from the outline buffer 13 with reference to the bit position information outputted from the control part 15, like that in accordance with above-mentioned Embodiment 1.

After acquiring the pieces of outline information about the graphics (4) and (5), the pixel creating part 14 creates pixels with reference to both the pieces of outline information and the attribute data about the graphics (4) and (5) outputted from control part 15, and draws the pixels in the frame buffer 16.

As a result, the drawing of the graphics (1) to (5) is completed.

As can be seen from the above description, the vector graphic drawing device in accordance with this Embodiment 3 is constructed in such a way that when there are many graphics which are targets to be drawn, and the number of bits required to store the pieces of outline information about all the graphics cannot be reserved in the outline buffer 13, the outline drawing part 12 stores the pieces of outline information about some graphics in the outline buffer 13, and, after the pixel creating part 14 creates pixels with reference to the outline information stored in the outline buffer 13, stores the pieces of outline information about the remaining graphics in the outline buffer 13. Accordingly, there is provided an advantage of being able to, even when there are many graphics which are targets to be drawn, and the number of bits required to store the pieces of outline information about all the graphics cannot be reserved in the outline buffer 13, carry out the process of drawing the graphics.

Although in either of above-mentioned Embodiments 1 to 3 the example in which the outline buffer 13 has an amount of storage corresponding to the same resolution as that of the frame buffer 16 is shown, the present invention is not limited to this example. For example, the amount of storage of the outline buffer 13 can be made to be less than that of the frame buffer 16, and the screen can be divided into a plurality of regions and the drawing of each graphic can be divided into a plurality of steps.

### Embodiment 4

In either of above-mentioned Embodiments 1 to 3, the example in which the outline buffer 13 is a memory having a storage element for each pixel and having the same resolution as the frame buffer 16 is shown. As an alternative, in a case in which the outline buffer 13 is constructed in such a way as to have a subpixel level of resolution and the outline drawing part 12 stores outline information acquired in units of a subpixel in the outline buffer 13, when creating pixels, the pixel creating part 14 can calculate the density of each pixel from a ratio of effective subpixels and determine the color of each pixel from the density.

Concretely, the pixel creating part operates as follows.

In this embodiment, for the sake of simplicity, it is assumed that the outline buffer 13 has a 4×4 subpixel resolution.

In this Embodiment 4, the outline drawing part 12 stores outline information acquired in units of a subpixel in the outline buffer 13.

After the outline drawing part 12 stores the outline information about a graphic which is acquired in units of a subpixel in the outline buffer 13, the pixel creating part 14 creates subpixels with reference to both the attribute data about the graphic provided from the control part 15, and the outline information acquired in units of a subpixel and stored in the outline buffer 13.

After creating subpixels, the pixel creating part 14 calculates the density of each pixel from the ratio of effective subpixels in the pixel.

For example, when eight ones among 16 subpixels (=4×4 subpixels) in a pixel are effective subpixels (i.e. subpixels for each of which outline information other than zero is stored), the density of the pixel is calculated as 50% (=(8/16)×100%).

Furthermore, for example, when four ones among 16 subpixels (=4×4 subpixels) in a pixel are effective subpixels, the density of the pixel is calculated as 25% (=(4/16)×100%).

After calculating the density of a pixel, the pixel creating part 14 determines the color of the pixel from the density. For example, in the case in which only a graphic (1) is associated with the pixel, the pixel creating part determines the color of the pixel as normal “blue” when the color shown by the attribute data about the graphic (1) is “blue” and the density is 100%.

In the case in which only the graphic (1) is associated with the pixel, the pixel creating part determines the color of the pixel as “blue” more blackish than the normal blue when the color shown by the attribute data about the graphic (1) is “blue” and the density is 50%.

Furthermore, for example, in the case in which the graphic (1) and a graphic (2) are associated with the pixel, the pixel creating part determines the color of the pixel as “yellow” which is an intermediate color between green and red when the color shown by the attribute data about the graphic (1) is “green” and the density is 100%, and the color shown by the attribute data about the graphic (2) is “red” and the density is 100%.

In the case in which the graphics (1) and (2) are associated with the pixel, the pixel creating part determines the color of the pixel as “orange” more reddish than yellow when the color shown by the attribute data about the graphic (1) is “green” and the density is 50%, and the color shown by the attribute data about the graphic (2) is “red” and the density is 100%.

As can be seen from the above description, the vector graphic drawing device in accordance with this Embodiment 4 is constructed in such a way that the outline buffer 13 is formed to have a subpixel level of resolution, and, when the outline drawing part 12 stores the outline information about a graphic which is acquired in units of a subpixel in the outline buffer 13, the pixel creating part 14 creates subpixels with reference to the outline information acquired in units of a subpixel, and, after that, calculates the density of each pixel from the ratio of effective subpixels and determines the color of each pixel from the above-mentioned density. Accordingly, there is provided an advantage of being able to draw each pixel with the color in which the attributes of all graphics overlapping one another at the pixel are reflected.

### INDUSTRIAL APPLICABILITY

As mentioned above, the vector graphic drawing device in accordance with the present invention is suitable for use as a vector graphic drawing device which needs to draw a plurality of graphics having an overlapping portion at a high speed.

1. A vector graphic drawing device provided with a coordinate transforming unit for transforming coordinates of vector data which construct an outline of a graphic into coordinates on a frame buffer, an outline drawing unit for converting the vector data whose coordinates are transformed by said coordinate transforming unit into raster data to determine a point of intersection of the outline of said graphic and each scan line, and for storing outline information showing said point of intersection in an outline buffer, and a pixel creating unit for creating pixels with reference to the outline information stored in said outline buffer, and for drawing said pixels in said frame buffer, wherein
when drawing a plurality of graphics, said outline drawing unit stores outline information about the plurality of graphics in said outline buffer, and, when creating the pixels, said pixel creating unit refers to the outline information about the plurality of graphics stored in said outline buffer to determine a color of each pixel in a portion in which the plurality of graphics overlap one another, and draws said pixels in said frame buffer.

2. The vector graphic drawing device according to claim 1, wherein in a case in which a Non-Zero rule is applied as a fill rule at a time when the pixels are created by the pixel creating unit, when storing the outline information about each of the graphics in the outline buffer, the outline drawing unit reserves only a number of bits required to express a value ranging from a minimum to a maximum of said outline information on said outline buffer.

3. The vector graphic drawing device according to claim 1, wherein in a case in which an Even-Odd rule is applied as a fill rule at a time when the pixels are created by the pixel creating unit, when storing the outline information about each of the graphics in the outline buffer, the outline drawing unit reserves only one bit on said outline buffer.

4. The vector graphic drawing device according to claim 1, wherein when there are a large number of graphics to be drawn, and a number of bits required to store the outline information about all the graphics cannot be reserved in the outline buffer, the outline drawing unit stores outline information about some of all the graphics in said outline buffer, and, after the pixel creating unit creates the pixels with reference to the outline information stored in said outline buffer, stores outline information about remaining graphics in said outline buffer.

5. The vector graphic drawing device according to claim 1, wherein the pixel creating unit makes the color of each pixel in the portion in which the plurality of graphics overlap one another match a color of a graphic which will be drawn later.

6. The vector graphic drawing device according to claim 1, wherein in a case in which the outline buffer has a subpixel level of resolution and the outline drawing unit stores outline information acquired in units of a subpixel in said outline buffer, the pixel creating unit creates subpixels with reference to the outline information acquired in units of a subpixel, and, after that, calculates a density of each pixel from a ratio of effective subpixels and determines a color of said each pixel from said density.
